(19) United States
(12) Patent Application Publication
(10) Pub. No.: US 2015/0316371 A1
(43) Pub. Date: Nov. 5, 2015

(54) METHOD FOR DETERMINING THE ABSOLUTE POSITION OF A LINEAR ACTUATOR

(71) Applicant: CONTINENTAL TEVES AG & CO. OHG, Frankfurt (DE)

(72) Inventors: Jürgen Böhm, Oberneisen (DE); Marco Besier, Bad Schwalbach (DE); Tom Kaufmann, Ippenschied (DE); Peter Stauder, Mainz (DE); Andreas Schirling, Darmstadt (DE)

(21) Appl. No.: 14/367,316

(22) PCT Filed: Nov. 28, 2012
(86) PCT No.: PCT/EP2012/073880

§ 371 Date: Jun. 20, 2014

(30) Foreign Application Priority Data
Dec. 23, 2011 (DE) 10 2011 089 820.4

(51) Int. Cl. G01B 21/22

(52) U.S. Cl. CPC G01B 21/22

(57) ABSTRACT

A method for determining the absolute position of a linear actuator is described. In the process, the rotational angle position of the rotor of the corresponding electric motor of the linear actuator is determined by a first sensor. In addition, the rotary angle position of a transmitter wheel of a second sensor coupled to the rotor is determined by means of a special transmission ratio. The absolute position of the linear actuator is derived from the differential value of the determined rotary angle positions. The method can be implemented in a simple and inexpensive manner.

### CROSS REFERENCE TO RELATED APPLICATIONS

This application is the U.S. National Phase Application of PCT/EP2012/073880, filed Nov. 28, 2012, which claims priority to German Patent Application No. 10 2011 089 820.4, filed Dec. 23, 2011, the contents of such applications being incorporated by reference herein.

### FIELD OF THE INVENTION

The present invention relates to a method for determining the absolute position of a linear actuator.

### BACKGROUND OF THE INVENTION

In many electromechanically activated systems, in particular brake systems, linear actuators are used which have, in addition to the actual actuator element, an electric motor and at least one transmission which is connected downstream for driving the actuator element. An example of such a transmission is a ball screw drive.

When operating such systems it is necessary to know, in addition to the movement path of the linear actuator, the absolute position thereof. The use of a linearly measuring actuator position sensor is a possible way here of determining the position of the linear actuator.

Another possibility is to determine the change in the angular position of the rotor of the associated electric motor of the linear actuator by means of a sensor, and to calculate the change in position of the linear actuator from said change. Such a rotor position sensor is necessary to operate the motor if an electronically commutated motor such as, for example, a synchronous machine, is used. Owing to the selected transmission ratios, a plurality of revolutions of the motor is usually necessary in order to pass through the entire actuator stroke. If it is assumed that the linear actuator position and the rotor position are read in with the same resolution and accuracy, it is possible to form, by summing the change in the rotor position, a replacement signal for the actuator position which is more accurate and many times resolved more highly than the signal of an actuator position sensor.

However, in order to use the actuator position replacement signal (by detecting the change in the rotor position), the latter must be referenced to the actual actuator position. It is known here to implement this by means of structural measures which ensure that at the system start the actuator is located at a known position (ratchet, spring). Another measure consists in providing a reference run of the actuator. However, both methods have disadvantages. The provision of additional structural elements entails additional costs and extends the field of possible error sources and is usually appropriate only when a corresponding functionality is also required elsewhere (for example ratchet for a parking brake). In order to carry out a reference run at the system start, a number of peripheral conditions must be satisfied. The actuator must be freely movable and there must be no external influence on the system, and the time for carrying out the reference run must be available every system start. This leads to restrictions on the system availability and to the need to reliably rule out external influences on the reference run.

### SUMMARY OF THE INVENTION

An aspect of the present invention is a method for determining the absolute position of a linear actuator which can be carried out in a particularly simple and cost-effective way.

This s achieved by means of a method for determining the absolute position of a linear actuator, which method comprises the following steps:

determining the rotational angle position of the rotor of the associated electric motor of the linear actuator with a first sensor;

determining the rotational angle position of a transmitter wheel, coupled to the rotor by means of a special transmission ratio, of a second sensor;

and

calculating the difference value from the determined rotational angle positions and deriving the absolute position of the linear actuator from the determined difference value.

According to an aspect of the invention it is therefore proposed to provide the linear actuator with a second rotational sensor which is coupled with a specially selected transmission ratio, with the result that the rotational angle position of the rotor and the rotational angle position which results from a rotation of the rotor with a transmission ratio can be detected. A difference value from which the linear absolute position of the linear actuator can be derived is calculated from the determined rotational angles.

The absolute position of the actuator is therefore obtained from the following relationship:

absolute position of the actuator=determined difference angle x theoretical total stroke/360°

The term “theoretical total stroke” is to be understood here as meaning the detection range multiplied by the gradient of the system.

Since the difference angle changes over the number of revolutions, the absolute position of the linear actuator can be determined therefrom.

The coupling of the transmitter wheel of the second sensor to the rotor preferably takes place by means of a positively locking transmission. A transmission ratio of 1:x is preferably selected for this, wherein x represents a value which differs slightly from an integer. In one particularly preferred embodiment, a transmission ratio of 1:2.1 is used, wherein here, for example, a transmitter wheel of the second sensor with 42 teeth is used, and a transmitter wheel of the first sensor with 20 teeth is used.

For the example with a transmission ratio of i=1:2.1 it is possible to generate, by applying the following computational rule

difference angle X=rotational angle of the rotor−2*rotational angle of the second sensor,

a monotonously rising signal over approximately 10 revolutions of the motor, which signal can be used directly as a position signal by multiplying with the transmission ratio and offsetting with a linear offset.

The absolute position of the linear actuator is generally determined from the rotational angle difference, preferably while taking into account a linear offset.

With respect to the angular offset, more precise details on the method are as follows:

During production or during a reference run of the system, the angular offsets of the two sensors are measured and stored in a known position. The known position is appropriately an end position. After the system has been switched on, an angle 1 is then formed from angle_{—}1=a tan sin 1/cos 1)−angular offset_{—}1 and an angle 2 from angle_{—}2=a tan(sin 2/cos 2)−angular offset_{—}2. In the end position both angles=0. The further evaluation can then be carried out by means of the described equations. In order to operate the electric motor, a further angular offset is necessary which describes the angular difference between the rotor angle formed from a tan(sin 1/cos 1) and the position of the permanent magnets. An angle_motor=a tan(sin/cos)−angular offset_motor is formed hereby and used for adjusting the motor.

After the absolute position of the linear actuator has been determined it is advantageous to use only the first sensor for acquiring the linear position of the linear actuator in order to eliminate the computational effort involved.

When rotor position sensors (first sensors) which are not directly absolute with respect to the electric motor position (for example: MR sensor and synchronous motor with uneven number of pole parts) are used, a rotor position replacement signal which is absolute with respect to one revolution of the motor can be formed using the actuator position replacement signal. The electric angular position of the electric motor which is necessary for commutation of the motor can then be obtained directly from this signal (and from offset values stored in the memory). In this way, the selection of the number of motor pole pairs and of the rotor position sensor used (first sensor) can be carried out independently of one another when the system is configured.

The method according to an aspect of the invention can be carried out easily and cost-effectively. Only one second sensor is necessary. Structural measures when ensure that the actuator is located at a known position at the system start are not necessary. Furthermore there is no need to carry out a reference run at the system start.

### BRIEF DESCRIPTION OF THE DRAWINGS

Aspects of the invention will be explained in detail below by means of an exemplary embodiment in conjunction with the drawing, in which:

FIG. 1 shows a diagram of the raw signals of the rotor sensor (first sensor) and of the second sensor; and

FIG. 2 shows a diagram showing the output signal over rotations of the motor.

### DETAILED DESCRIPTION OF THE INVENTION

In the exemplary embodiment described here, the first sensor (rotor position sensor) is seated centrally on the motor shaft and has a gearwheel with 20 teeth. A second sensor, the transmitter wheel of which has 42 teeth and meshes with the gearwheel of the first sensor, is arranged parallel next to this first sensor. The second sensor is therefore coupled to the first sensor with a transmission ratio of i=1:2.1.

The corresponding sensing of the gearwheels occurs by means of magnets. The evaluation of the signals is carried out by means of circuit boards with two sensor/ICs.

In another embodiment, the angular position of the gearwheels is determined by measuring the direction of the emitted magnetic field of magnets, which are connected in a positively locking fashion to the gearwheels, by means of two magnetic sensors (preferably MR sensors).

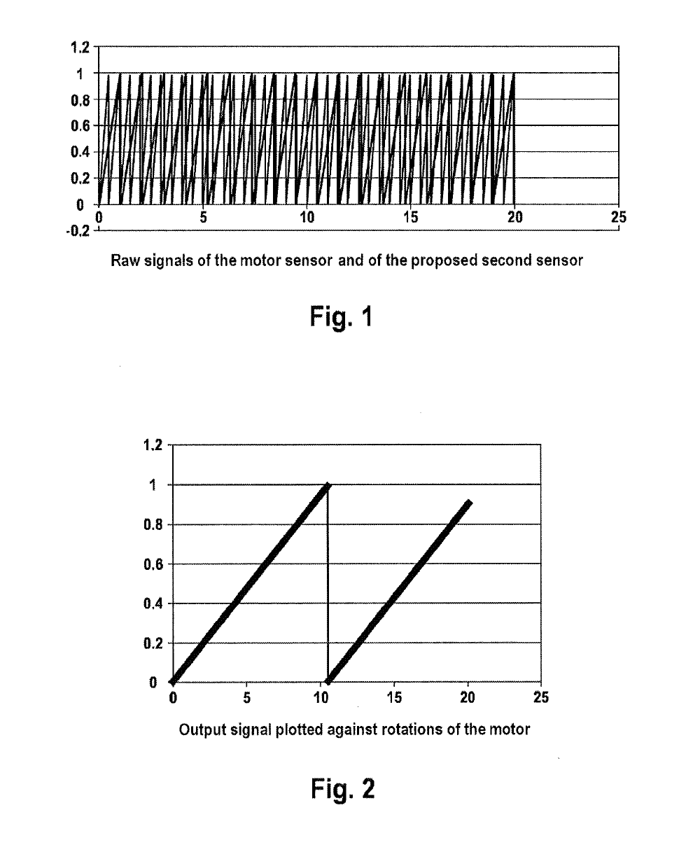

FIG. 1 illustrates the raw signals of the rotor sensor (first sensor) and of the second sensor which present the profile of the measured rotations with respect to the rotations of the motor. By means of the computational rule

rotational angle difference X=rotor angle−2*angle sensor 2,

a monotonously rising signal can be generated over approximately 10 rotations of the motor, which signal can be used directly as a position signal by multiplying by the transmission ratio and offsetting with a linear offset. This signal is illustrated in FIG. 2. As mentioned, before the calculation is carried out the offsets of the two sensors must be subtracted, i.e. the angular values which are obtained when the linear actuator is located in the end position.

1. A method for determining an absolute position of a linear actuator, comprising:
determining a rotational angle position of a rotor of an associated electric motor of the linear actuator with a first sensor;
determining a rotational angle position of a transmitter wheel, coupled to the rotor by a special transmission ratio, of a second sensor; and
calculating a difference value from the determined rotational angle positions and deriving the absolute position of the linear actuator from the determined difference value.

2. The method as claimed in claim 1, wherein a transmission ratio of 1:x is selected, wherein x represents a value which differs slightly from an integer.

3. The method as claimed in claim 1, wherein a transmission ratio of 1:2.1 is used.

4. The method as claimed in claim 3, wherein a transmitter wheel of the second sensor with 42 teeth is used, and a transmitter wheel of the first sensor with 20 teeth is used.

5. The method as claimed in claim 1, wherein the absolute position of the linear actuator is determined from the rotational angle difference while taking into account a linear offset.

6. The method as claimed in claim 1, wherein after the absolute position of the linear actuator has been determined only the first sensor is used to acquire the linear position of the linear actuator.
